(19) United States
(12) Patent Application Publication
(10) Pub. No.: US 2019/0236439 A1
(43) Pub. Date: Aug. 1, 2019

(54) RESOURCE ALLOCATION BASED ON DECOMPOSED UTILIZATION DATA

(71) Applicant: HEWLETT PACKARD ENTERPRISE DEVELOPMENT LP, Houston, TX (US)

(72) Inventors: Prajwal D, Bangalore (IN); Gaurav Jain, Bangalore (IN); Kumaresan Ellappan, Bangalore (IN)

(21) Appl. No.: 15/884,922

(22) Filed: Jan. 31, 2018

(51) Int. Cl. G06N 3/04; G06F 9/50; G06N 3/08

(52) U.S. Cl. CPC G06N 3/0454; G06N 3/084; G06F 9/5027

(57) ABSTRACT

A computing device includes at least one hardware processor and a machine-readable storage medium. The machine-readable storage medium stores instructions executable by the processor to: perform empirical mode decomposition of utilization data for a computing resource to generate a plurality of component functions; generate a plurality of neural networks via the plurality of component functions; generate, via the plurality of neural networks, a composite utilization forecast for the computing resource; and allocate the computing resource based on the composite utilization forecast.

### BACKGROUND

Resource allocation is the process of allocating computing resources to computing systems. In some examples, a datacenter may be configurated to include particular numbers and types of computing devices. Further, in some examples, the datacenter may be configurated with specific network devices and interconnections to allow the computing devices to communicate data via an internal network (e.g., a local area network) and/or an external network (e.g., the Internet).

### BRIEF DESCRIPTION OF THE DRAWINGS

Some implementations are described with respect to the following figures.

FIG. 1 is a schematic diagram of an example system, in accordance with some implementations.

FIG. 2 is an illustration of an example allocation operation, in accordance with some implementations.

FIG. 3A is an illustration of an example data decomposition, in accordance with some implementations.

FIG. 3B is a flowchart of an example decomposition process, in accordance with some implementations.

FIG. 4 is an illustration of an example neural network, in accordance with some implementations.

FIG. 5 is a flowchart of an example allocation process, in accordance with some implementations.

FIG. 6 is a schematic diagram of an example computing device, in accordance with some implementations.

FIG. 7 is a diagram of an example machine-readable storage medium storing instructions in accordance with some implementations.

### DETAILED DESCRIPTION

In some examples, a management device may automatically allocate a computing resource to a computing system (e.g., a datacenter) based on data regarding the past utilization of the computing resource. For example, the management device may use utilization data to forecast future resource requirements, and may allocate the resource according to the forecast. However, the utilization data of computing resources can be non-linear and/or non-stationary. For example, a datacenter may include a large number of devices that can include various types of computing resources, can be arranged in complex configurations, and can be used by any number of clients at various times. Accordingly, the utilization data for a computing resource in a datacenter may vary in an irregular and unpredictable manner over time. As such, the management device may be unable to forecast resource requirements with sufficient accuracy to automatically allocate the resource.

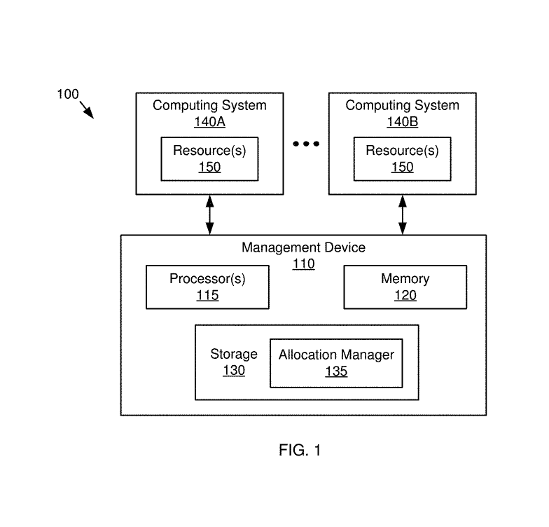

In accordance with some implementations, examples are provided for automatic resource allocation based on decomposed utilization data. As described further below with reference to FIGS. 1-7, some implementations may involve decomposing utilization data that indicates past use of a computing resource into component functions. The component functions may be used to train multiple neural networks. The outputs of the neural networks may be combined to generate a utilization forecast for the computing resource. The computing resource may be allocated to a computing system based on the utilization forecast. One or more implementations may generate forecasts for resources and/or systems having nonlinear and/or nonstationary utilization. Accordingly, one or more implementations may provide automated allocation of computing resources in an accurate manner

FIG. 1 shows a schematic diagram of an example system 100, in accordance with some implementations. As shown, in some implementations, the system 100 may include a management device 110 to allocate resources 150 to any number of computing systems 140A-140N (also referred to collectively as “computing systems 140,” or individually as a “computing system 140”). In some examples, some or all of the computing systems 140 may each be a datacenter (e.g., a defined facility including multiple computing devices). Further, in other examples, the computing systems 140 may include servers, desktop computers, appliances, laptops, clusters, communication devices, network devices, and so forth.

In some implementations, the management device 110 may be a computing device including processor(s) 115, memory 120, and machine-readable storage 130. The processor(s) 115 can include a microprocessor, a microcontroller, a processor module or subsystem, a programmable integrated circuit, a programmable gate array, multiple processors, a microprocessor including multiple processing cores, or another control or computing device. The memory 120 can be any type of computer memory (e.g., dynamic random access memory (DRAM), static random-access memory (SRAM), etc.). In some implementations, the machine-readable storage 130 can include non-transitory storage media such as hard drives, flash storage, optical disks, etc.

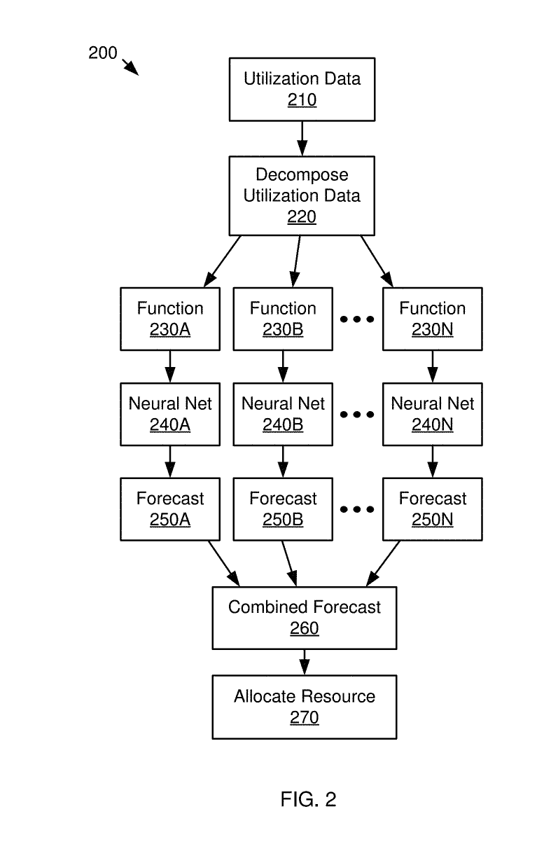

As shown, the machine-readable storage 130 can include an allocation manager 135. The allocation manager 135 may be implemented in hardware or machine-readable instructions (e.g., software and/or firmware). The machine-readable instructions are stored in a non-transitory computer readable medium, such as an optical, semiconductor, or magnetic storage device. In one or more implementations, the allocation manager 135 can decompose utilization data for a resource 150 into component functions. As used herein, the term “component function” refers to one of multiple functions that are generated by decomposing a single source function. The allocation manager 135 may use the component functions to train a set of neural networks. Further, the allocation manager 135 may combine the outputs of the neural networks to generate a utilization forecast. Furthermore, the allocation manager 135 may allocate an amount of the resource 150 to a computing system 140 based on the utilization forecast. The functions of the allocation manager 135 are discussed further below with reference to FIGS. 2-7.

Referring now to FIG. 2, shown is an illustration of an example allocation operation 200 in accordance with some implementations. In some examples, some or all of the allocation operation 200 may be performed by the allocation manager 135 (shown in FIG. 1). As shown in FIG. 2, the allocation operation 200 includes receiving utilization data 210. In some implementations, the utilization data indicate the past usage of a computing resource by a computing system. For example, the utilization data may indicate the past usage of a physical component (e.g., processor, storage device, network device, etc.). In another example, the utilization data may indicate the past usage of a virtual or software component (e.g., a virtual machine (VM), a virtual network function (VNF), an application, a license, etc.).

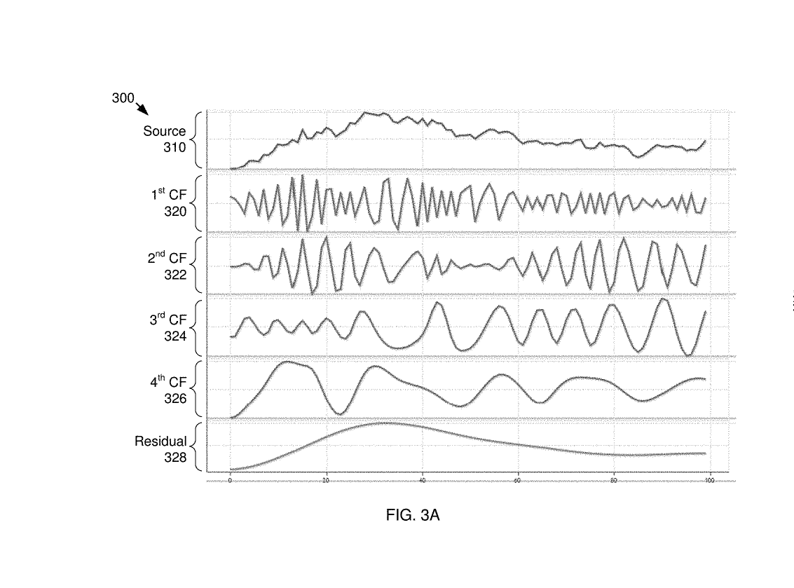

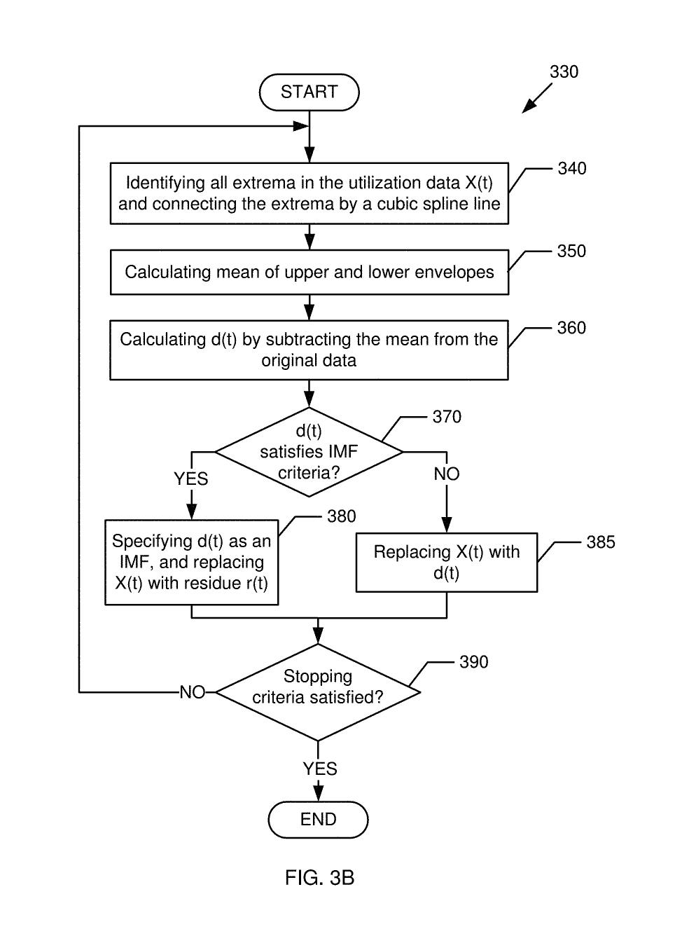

As shown, the allocation operation 200 includes decomposing 220 the utilization data into a set of component functions 230A-230N (also referred to collectively as “component functions 230,” or individually as a “component function 230”). In one or more implementations, the decomposing 220 be performed using empirical mode decomposition (EMD). When using empirical mode decomposition, the decomposed component functions 230 are referred to as intrinsic mode functions (IMFs). Example implementations of empirical mode decomposition are discussed below with reference to FIGS. 3A-3B.

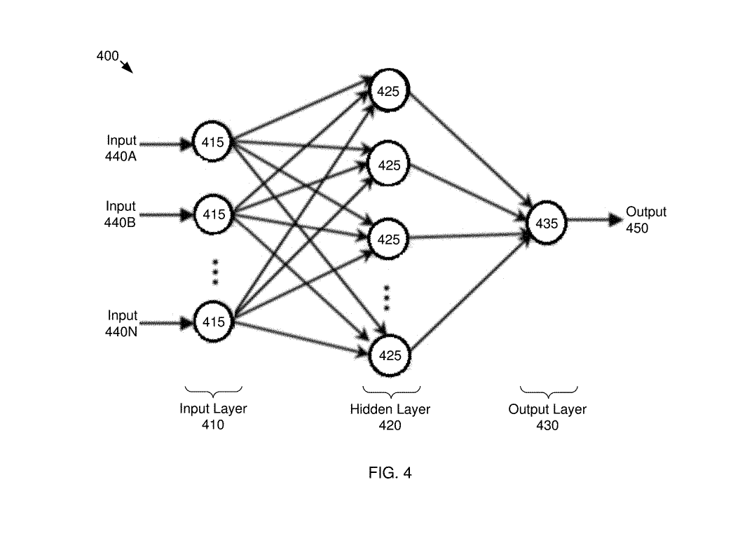

In one or more implementations, the component functions 230A-230N are used to train a set of neural networks 240A-240N (also referred to collectively as “neural networks 240,” or individually as a “neural network 240”). In some examples, each component function 230 may be used to train a corresponding neural network 240 (e.g., component function 230A is used to train neural network 240A). Further, in some examples, some or all of the neural networks 240 may be back-propagation artificial neural networks (BPANNs). An example implementation of a BPANN is discussed below with reference to FIG. 4.

In one or more implementations, the neural networks 240 may be used to generate a set of forecast values 250A-250N (also referred to collectively as “forecast values 250,” or individually as a “forecast value 250”). Each forecast value 250 may be a forecast corresponding to an associated component function 230. For example, the forecast value 250A may represent an expected future value associated with the component function 230A.

As shown, the allocation operation 200 includes combining the forecast values 250A-250N to generate a combined forecast 260 (also referred to as a “composite forecast”) that indicates the expected usage of a computing resource. In one or more implementations, generating the combined forecast 260 may include summing the forecast values 250A-250N.

In one or more implementations, the allocation operation 200 further includes allocating 270 the computing resource based on the combined forecast. In some examples, the allocating 270 can be performed with respect to the combined forecast for a single computing system. For example, the allocating 270 may include allocating a VNF to a particular datacenter in response to a combined forecast indicating that the expected usage of the VNF at the particular datacenter exceeds a defined threshold. Further, in some examples, the allocating 270 may include allocating a resource to one of multiple computing systems based on combined forecasts associated with multiple computing systems. For example, the allocating 270 may include comparing multiple combined forecasts indicating the expected usage of a VNF at multiple datacenters, and allocating the VNF to the datacenter having the largest expected usage of the VNF.

Referring now to FIG. 3A, shown is an illustration of an example data decomposition 300, in accordance with some implementations. In some examples, some or all of the example data decomposition 300 may be performed by the allocation manager 135 (shown in FIG. 1). Note that FIG. 3A includes various function graphs (labeled 310-328) that each have a horizontal axis and a vertical axis. Assume that the horizontal axis represents time and the vertical axis represents a utilization value.

As shown, the example data decomposition 300 includes a source function 310. The source function 310 may be a function representing the utilization for a computing resource. For example, the source data 310 may be a time series of measured utilization values for a given computing resource at a particular computing system.

In the example of FIG. 3A, the source function 310 is decomposed into four component functions (CFs) 320-326 and a residual function 328. In one or more implementations, the source function 310 may be decomposed using empirical mode decomposition (EMD). Accordingly, the CFs 320-326 may be referred to as intrinsic mode functions (IMFs). The CFs 320-326 may correspond generally to the components functions 240 shown in FIG. 2. Assume that the order of the functions shown in FIG. 3A, from top to bottom, represents the sequence in which the functions are generated. For example, assume that CF 320 is generated from source function 310, CF 322 is generated from CF 320, CF 324 is generated from CF 322, and so forth. Note that, as shown in FIG. 3A, each of the CFs 320-326 and the residual function 328 may span the same time period as the source function 310.

Referring now to FIG. 3B, shown is a flowchart of an example decomposition process 330, in accordance with some implementations. The decomposition process 330 may correspond generally to an example implementation of empirical mode decomposition. In one or more examples, some or all of the example decomposition process 330 may be performed by the allocation manager 135 (shown in FIG. 1).

Block 340 may include identifying all extrema in utilization data X(t), and connecting the extrema by a cubic spline line. The upper envelope line may be denoted as Max(t), and the lower envelope line may be denoted as Min(t). For example, referring to FIGS. 1 and 3A, the allocation manager 135 may define an upper envelope line Max(t) to connect the upper extreme points of the source function 310 (also referred to as utilization data X(t)), and may define a lower envelope line Min(t) to connect the lower extreme points of the source function 310. The value t may correspond to time value(s) along the horizontal axis shown in FIG. 3A.

Block 350 may include calculating the mean of the upper envelope Max(t) and the lower envelope Min(t). For example, referring to FIG. 1, the allocation manager 135 may calculate the formula Mean(t)=(Max(t)+Min(t))/2.

Block 360 may include calculating d(t) by subtracting the mean from the original data. For example, referring to FIG. 1, the allocation manager 135 may calculate the formula d(t)=X(t)−Mean(t).

Diamond 370 may include determining whether d(t) satisfies criteria defining an intrinsic mode function (IMF). For example, referring to FIG. 1, the allocation manager 135 may determine whether d(t) satisfies calculate the following conditions defining a valid IMF: (i) the number of extrema of d(t) (i.e., the sum of the maxima and minima) and the number of zero-crossings (i.e., crossings of the zero axis) must either be equal or differ at most by one, and (ii) at any point of d(t), the mean value of the envelope defined by the local maxima and the envelope defined by the local minima must be zero.

If it is determined at diamond 370 that d(t) satisfies the IMF criteria, then at block 380, d(t) is specified as an IMF, and X(t) is replaced with a residue function r(t). Note that the decomposition process 330 may generate multiple IMFs, and thus d(t) is denoted as a particular IMF in a sequence (e.g., first IMF, second IMF, etc.). For example, referring to FIG. 3A, the first component function (CF) 320 may represent the first IMF that was generated by the decomposition process 330, the second CF 322 may represent the second IMF that was generated by the decomposition process 330, and so forth.

However, if it is determined at diamond 370 that d(t) does not satisfy the IMF criteria, then at block 385, the utilization data X(t) is replaced by d(t). Stated differently, the function d(t) resulting from one iteration of the decomposition process 330 may be used as the input X(t) of a following iteration of the decomposition process 330. After either block 380 or block 385, the decomposition process 330 continues at diamond 390.

Diamond 390 may include determining whether stopping criteria for the decomposition process 330 have been satisfied. For example, referring to FIG. 1, the allocation manager 135 may stop the decomposition process 330 when the number of zero-crossings in d(t) are below a defined threshold (e.g., are less than two), when the number of zero-crossings has not changed for a given number of iterations, and so forth. For example, referring to FIG. 3A, the residual function 328 may correspond to the instance of d(t) remaining after satisfying the stopping criteria.

If it is determined at diamond 390 that the stopping criteria have not been satisfied, then the decomposition process 330 may return to block 340 to begin another iteration (i.e., to again perform a calculation of d(t)). However, if it is determined at diamond 390 that the stopping criteria have been satisfied, the decomposition process 330 is completed.

Referring now to FIG. 4, shown is an illustration of an example neural network 400, in accordance with some implementations. In some examples, the neural network 400 may be generated and/or trained by the allocation manager 135 (shown in FIG. 1). Further, the neural network 400 shown in FIG. 4 may correspond generally to an example implementation of one of the neural networks 240 (shown in FIG. 2). In some implementations, the neural network 400 may be a back-propagation artificial neural networks (BPANN).

As shown in FIG. 4, the neural network 400 may include an input layer 410, a hidden layer 420, and an output layer 430. In some examples, the input layer 410 may include input nodes 415 to receive multiple N inputs 440A-440N. Each input node 415 may be coupled to multiple hidden nodes 425 in the hidden layer 420. Further, the hidden nodes 425 may be coupled to an output node 435 that provides a neural net output 450.

In some implementations, the output of any node in the neural network 400 can be represented by the following formula: Hⱼ=f(sum(wᵢⱼxᵢ-bⱼ)), where the sum is performed for each i=1 to n, n is the number of inputs, xᵢ is the ith input, wᵢⱼ is the weight associated with a connection between the jth and ith nodes, bⱼ is the threshold, and f is a nonlinear activation function. In some examples, the starting weights and thresholds of the nodes (i.e., at start of a training process) may be set randomly. The training process may include performing multiple iterations that each include providing input values, adjusting the weights and thresholds, and determining whether the output of the neural network 400 matches a desired value. Such iterations may be performed until the output converges on the desired value within a given error threshold or percentage. In some examples, the training process may be completed to set the weights and threshold values that cause the output of the neural network 400 to match a desired output value associated with a specific set of inputs. In some examples, the desired value may be defined to be the actual decomposed value of the training data set.

In one or more implementations, each neural network 400 may be trained using a unique component function (e.g., component function 230 shown in FIG. 2) that is decomposed from utilization measurements for a resource. The training of a neural network 400 may include forward propagation of input data from the input layer 410 to the output layer 430. The training may also include backward propagation of errors through the neural network 400 for errors that do not meet a given tolerance. The training may also include updating weight and threshold values of the nodes by the backward propagation of errors until the error value meets a given tolerance.

In one or more implementations, the input values 440A-440N may be a subset of the data values in the input component function. For example, the input values 440A-440N may represent a given time period (e.g., one week) of utilization measurements for a computing resource at a datacenter. In some implementations, the training of neural network 400 may be performed in multiple iterations, with each iteration using the utilization values included different time periods. In some examples, such iterations may use input values from overlapping time periods. For example, a first iteration may use input values X(1)-X(6), a second iteration may use input values X(2)-X(7), the third iteration may use input values X(3)-X(8), and so forth. In this example, X(1) is a value measured at time 1, X(2) is a value measured at time 2, and so forth. In one or more implementations, the number N of the input values 440A-440N may be determined to balance the convergence speed and the forecasting accuracy of the neural network 400.

In one or more implementations, after completing the training process, the neural network 400 may be validated using measured utilization data for the resource. For example, the neural network 400 may be used to generate forecast values using an earlier portion of actual utilization data, and the forecast values may be compared to a later portion of the actual utilization data. This comparison may be used to calculate a forecasting error value for the neural network 400. In some examples, the neural network 400 may be considered to be validated if the error value is below a specified threshold (e.g., below 10%). However, if the error value is above the specified threshold, the training process may be repeated. Once the neural network 400 is trained and validated, the neural network 400 may be used to generate a forecast value for the input component function. Further, the forecast values for multiple component functions may be used to generate a combined forecast for a resource.

Note that, while FIGS. 1-4 show example implementations, other implementations are possible. For example, while FIG. 1 shows the allocation manager 135 to be implemented as instructions stored in the machine-readable storage 130, it is contemplated that some or all of the allocation manager 135 could be hard-coded as circuitry included in the processor(s) 115 and/or the management device 110. In other examples, some or all of the allocation manager 135 could be implemented as instructions executed on a remote computer (not shown), as a web service, and so forth. In another example, the allocation manager 135 may be implemented in one or more controllers of the management device 110. In yet another example, it is contemplated that the management device 110 may include additional components. Other combinations and/or variations are also possible.

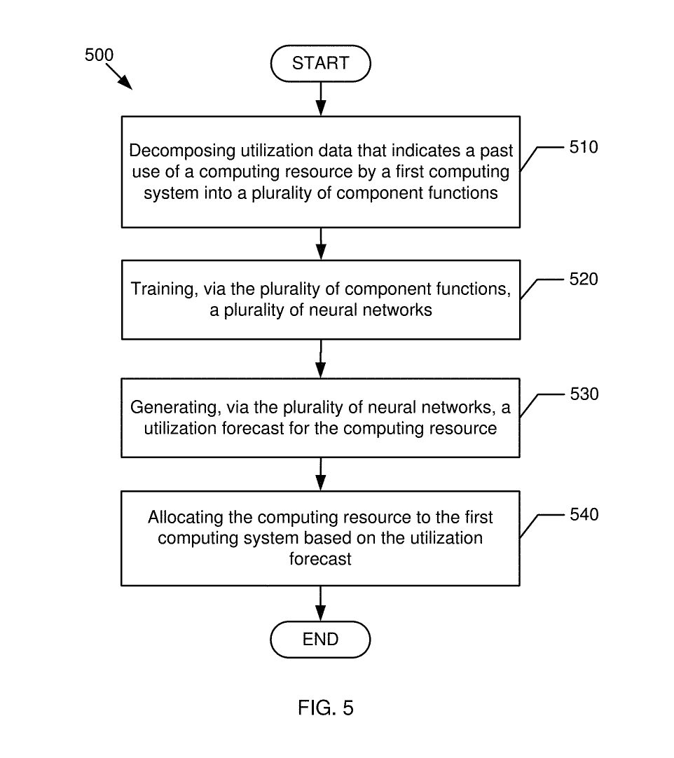

Referring now to FIG. 5, shown is a flowchart of an example allocation process 500, in accordance with some implementations. The process 500 may be performed by the allocation manager 135 shown in FIG. 1. The process 500 may be implemented in hardware or machine-readable instructions (e.g., software and/or firmware). The machine-readable instructions are stored in a non-transitory computer readable medium, such as an optical, semiconductor, or magnetic storage device. For the sake of illustration, details of the process 500 may be described below with reference to FIGS. 1-4, which show examples in accordance with some implementations. However, other implementations are also possible.

Block 510 may include decomposing utilization data that indicates a past use of a computing resource by a first computing system into a plurality of component functions. For example, referring to FIGS. 1-2, the allocation manager 135 may decompose utilization data for a computing resource 150 into multiple component functions 230A-230N.

Block 520 may include training, via the plurality of component functions, a plurality of neural networks. For example, referring to FIGS. 1-2, the allocation manager 135 may train the neural networks 240A-240N using the component functions 230A-230N.

Block 530 may include generating, via the plurality of neural networks, a utilization forecast for the computing resource. For example, referring to FIGS. 1-2, the neural networks 240A-240N may generate forecasts 250A-250N. The allocation manager 135 may combine the forecasts 250A-250N to generate a combined forecast 260 that indicates the expected usage of the computing resource. In one or more implementations, generating the combined forecast 260 may include summing the forecast values 250A-250N.

Block 540 may include allocating the computing resource to the first computing system based on the utilization forecast. For example, referring to FIGS. 1-2, the allocation manager 135 may allocate the computing resource 150 to a computing system 140A based on the combined forecast 260. In some implementations, allocating the computing resource 150 may include selecting one of multiple computing system 140A-140N that has a highest forecast usage of the computing resource 150. After block 540, the process 500 is completed.

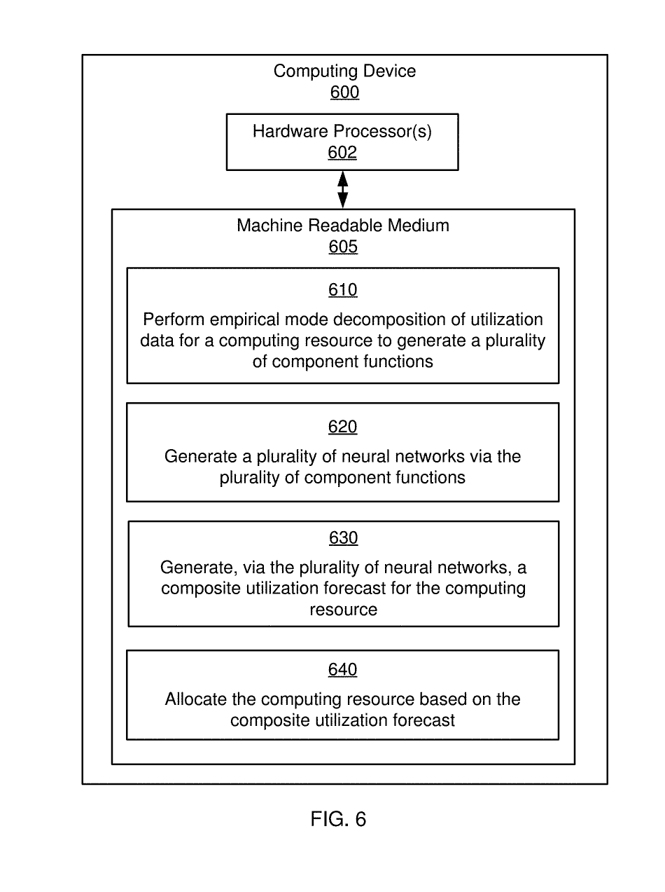

Referring now to FIG. 6, shown is a schematic diagram of an example computing device 600. In some examples, the computing device 600 may correspond generally to the management device 110 shown in FIG. 1. As shown, the computing device 600 may include hardware processor(s) 602 and a storage device 605. The hardware processor(s) 602 may execute instructions 610-640 stored in the storage device 605.

Instruction 610 may perform empirical mode decomposition of utilization data for a computing resource to generate a plurality of component functions. In some implementations, executing instruction 610 may include the decomposition process 330 discussed above with reference to FIG. 3B. In some examples, each component function may represent a decomposed factor of the past utilization of the computing resource.

Instruction 620 may generate a plurality of neural networks via the plurality of component functions. In some implementations, executing instruction 620 may generate multiple instances of the neural network 400 discussed above with reference to FIG. 4. In some examples, each generated neural network may be trained using a unique component function. Further, each neural network may generate a forecast value associated with the component function used to train that neural network.

Instruction 630 may generate, via the plurality of neural networks, a composite utilization forecast for the computing resource. In some implementations, generating a composite utilization forecast may include summing multiple forecast values (e.g., forecast values 250A-250N shown in FIG. 2).

Instruction 640 may allocate the computing resource based on the composite utilization forecast. In some examples, executing instruction 640 may include determining whether to allocate a particular computing resource to a particular computing system. In other examples, executing instruction 640 may include selecting one or more computing system from a plurality of computing systems to be assigned a given computing resource.

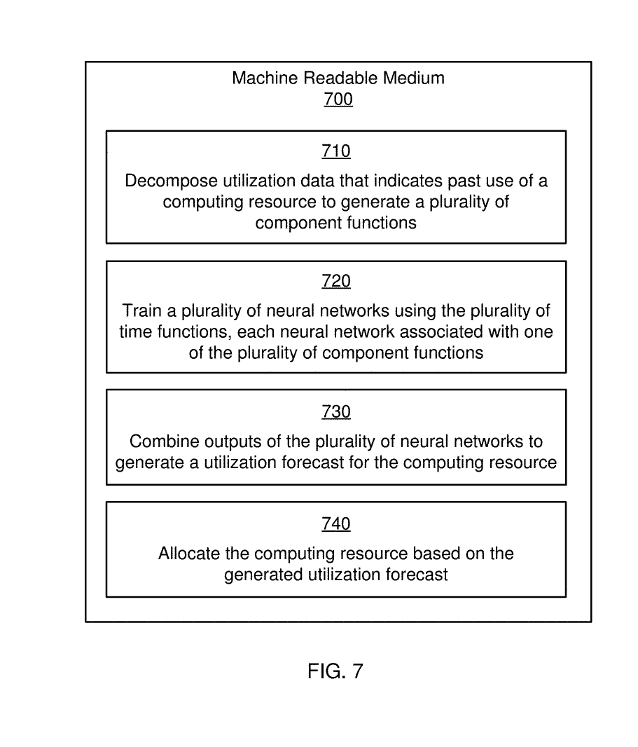

Referring now to FIG. 7, shown is a machine-readable storage medium 700 storing instructions 710-740, in accordance with some implementations. The instructions 710-740 can be executed by any number of processors (e.g., processor(s) 115 shown in FIG. 1). The machine-readable storage medium 700 may be any non-transitory computer readable medium, such as an optical, semiconductor, or magnetic storage device.

Instruction 710 may decompose utilization data that indicates past use of a computing resource to generate a plurality of component functions (e.g., component functions 320-326 discussed above with reference to FIG. 2). In some examples, the utilization data is a time series of measured values for the usage of a particular computing resource (e.g., a virtual network function) at a particular computing system (e.g., a datacenter). Further, in some examples, the plurality of component functions may be intrinsic mode functions (IMFs).

Instruction 720 may train a plurality of neural networks using the plurality of component functions, where each neural network is associated with one of the plurality of component functions. In some examples, the plurality of neural functions may be back-propagation artificial neural networks (BPANNs). Further, in some examples, training each neural network may include performing multiple iterations until a forecast error falls below a defined error threshold. Each iteration may include modifying weights and thresholds of the nodes in the neural network.

Instruction 730 may combine outputs of the plurality of neural networks to generate a utilization forecast for the computing resource. In some examples, executing instruction 730 may include summing forecast values associated with the plurality of component functions.

Instruction 740 may allocate the computing resource based on the generated utilization forecast. In some examples, executing instruction 740 may include determining whether to allocate a virtual network function to a particular datacenter. In other examples, executing instruction 740 may include selecting one or more datacenters from a plurality of datacenters to be assigned the virtual network function.

In accordance with some implementations, examples are provided for allocation of computing resources to computing systems. Some implementations include decomposing utilization data for a computing resource into component functions, and using the component functions to train multiple neural networks. The neural networks may generate forecast values that are combined to generate a composite utilization forecast for the computing resource. The computing resource may be allocated to a computing system based on the composite utilization forecast. In this manner, some implementations may provide automated and accurate allocation of computing resources to computing systems.

Data and instructions are stored in respective storage devices, which are implemented as one or multiple computer-readable or machine-readable storage media. The storage media include different forms of non-transitory memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices.

Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. A computing device, comprising:
at least one hardware processor;
a machine-readable storage medium storing instructions executable by the processor to:
perform empirical mode decomposition of utilization data for a computing resource to generate a plurality of component functions;
generate a plurality of neural networks via the plurality of component functions;
generate, via the plurality of neural networks, a composite utilization forecast for the computing resource; and
allocate the computing resource based on the composite utilization forecast.

2. The computing device of claim 1, the instructions executable by the processor to:
generate a plurality of forecast values via the plurality of neural networks; and
generate the composite utilization forecast based on a combination of the plurality of forecast values.

3. The computing device of claim 1, the instructions executable by the processor to:
train the plurality of neural networks using the plurality of component functions.

4. The computing device of claim 1, wherein each of the plurality of component functions is an Intrinsic Mode Function (IMF).

5. The computing device of claim 1, wherein the computing resource is a Virtual Network Function (VNF), and wherein the VNF is allocated to a datacenter based on the composite utilization forecast.

6. The computing device of claim 1, wherein each of the plurality of neural networks is a back-propagation artificial neural network (BPANN).

7. The computing device of claim 1, wherein a first neural network of the plurality of neural networks comprises a plurality of nodes, and wherein the plurality of nodes comprises an input layer, an output layer, and at least one hidden layer.

8. An article comprising a machine-readable storage medium storing instructions that upon execution cause a processor to:
decompose utilization data that indicates past use of a computing resource to generate a plurality of component functions;
train a plurality of neural networks using the plurality of component functions, each neural network associated with one of the plurality of component functions;
combine outputs of the plurality of neural networks to generate a utilization forecast for the computing resource; and
allocate the computing resource based on the generated utilization forecast.

9. The article of claim 8, wherein the outputs of the plurality of neural networks are a plurality of forecast values, and wherein each forecast function of the plurality of forecast functions is associated with a unique component function of the plurality of component functions.

10. The article of claim 9, including instructions that upon execution cause the processor to:
sum the plurality of forecast functions to generate the utilization forecast for the computing resource.

11. The article of claim 8, wherein each of the plurality of component functions is an Intrinsic Mode Function (IMF), and wherein each of the plurality of neural networks is a back-propagation artificial neural network (BPANN).

12. The article of claim 8, including instructions that upon execution cause the processor to:
select, via the generated utilization forecast, a first datacenter from a plurality of datacenters; and allocate the computing resource to the selected first datacenter.

13. The article of claim 8, wherein the computing resource is a Virtual Network Function (VNF).

14. The article of claim 8, wherein each of the plurality of neural networks comprises a plurality of nodes, and wherein the plurality of nodes comprises an input layer, an output layer, and a hidden layer.

15. A method, executable by a processor of a management device, the method comprising:
decomposing utilization data that indicates a past use of a computing resource by a first computing system into a plurality of component functions;
training, via the plurality of component functions, a plurality of neural networks;
generating, via the plurality of neural networks, a utilization forecast for the computing resource; and
allocating the computing resource to the first computing system based on the utilization forecast.

16. The computer implemented method of claim 15, further comprising:
generating a plurality of forecast values using the plurality of neural networks; and
generating the utilization forecast based on a combination of the plurality of forecast values.

17. The computer implemented method of claim 16, wherein the combination of the plurality of forecast values is a summation of the plurality of forecast values.

18. The computer implemented method of claim 15, wherein each of the plurality of neural networks comprises a plurality of nodes, and wherein training each of the plurality of neural networks comprises modifying weight values and threshold values of the plurality of nodes over a first plurality of iterations.

19. The computer implemented method of claim 18, wherein training each of the plurality of neural networks further comprises determining whether a neural network output matches a desired value within a defined error percentage.

20. The computer implemented method of claim 15, wherein decomposing the utilization data comprises:
generating the plurality of component functions over a second plurality of iterations; and
determining whether stopping criteria associated with the decomposing have been satisfied.
